(19) United States
(12) Patent Application Publication
(10) Pub. No.: US 2015/0348212 A1
(43) Pub. Date: Dec. 3, 2015

(54) Systems and Methods for Graphically Rendering Account Data

(71) Applicant: MASTERCARD INTERNATIONAL INCORPORATED, Purchase, NY (US)

(72) Inventor: Robert Ward, Braintree (GB)

(21) Appl. No.: 14/725,297

(22) Filed: May 29, 2015

(30) Foreign Application Priority Data
May 30, 2014 (GB) 1409657.2

(51) Int. Cl. G06Q 40/00; G06F 3/0484; G06F 3/0482; G06F 17/22

(52) U.S. Cl. CPC G06Q 40/12; G06F 17/2235; G06F 3/04842; G06F 3/0482

(57) ABSTRACT

A method comprising: processing account data obtained for one or more accounts to determine relative sizes of a quantitative attribute of a plurality of comparable account data elements; and rendering at least some of said account data graphically such that each of said account data elements is represented by an image, relative sizes of said images indicating relative sizes of the corresponding quantitative attributes of the account data elements.

### FIELD

The present disclosure generally relates to systems and methods for graphically rendering account data.

### BACKGROUND

This section provides background information related to the present disclosure which is not necessarily prior art.

Individuals and businesses are increasingly using online systems to access their financial information for bank accounts and payment cards.

Whether in paper form or when displayed through a graphical user interface (GUI) on a computer or a mobile device, the transaction history is typically presented in the form of tables of transactions and associated data. These tables are difficult to read and generally cannot be manipulated or rearranged by a user. This is especially true for mobile devices with small displays.

Multi-currency pre-paid cards are an example of a payment method whose use generates a great deal of data which can be hard to digest in traditional formats.

### SUMMARY

This section provides a general summary of the disclosure, and is not a comprehensive disclosure of its full scope or all of its features. Aspects and embodiments of the disclosure are also set out in the accompanying claims.

According to a first aspect there is provided a method comprising: processing account data obtained for one or more accounts to determine relative sizes of a quantitative attribute of a plurality of comparable account data elements; and rendering at least some of said account data graphically such that each of said account data elements is represented by an image, relative sizes of said images indicating relative sizes of the corresponding quantitative attributes of the account data elements.

The method could further comprise displaying the images on a graphical user interface.

The account data could be transactional data relating to transactions completed on said one or more accounts within a predetermined period. Said quantitative attribute could be either individual transaction amounts for each of said transactions or composite transaction amounts for a plurality of groups of said transactions.

The account data could be data relating to a plurality of digital purses associated with said one or more accounts. Said quantitative attribute could be a balance of each of said plurality of digital purses.

One or more of the images could be configured to be selectable by means of a user interface device to hyperlink to a rendering of further information relating to the respective account data elements.

The images could comprise a plurality of component images. One or more of said component images could be configured to be selectable by means of a user interface device to hyperlink to a rendering of further information relating to a subset of the account data elements whose representative images comprise a component image that has been selected.

Said processing could comprise extracting from the transactional data, for each transaction to which the transactional data relates, one or more attributes selected from: numerical value, currency, transaction type, merchant, merchant type, transaction date, settlement date and location.

Said processing could comprise converting the numerical value of each transaction to which the transactional data relates to a predetermined currency.

Said converting could comprise obtaining a currency conversion rate for a transaction date of each transaction to which the transactional data relates.

Said processing could comprise determining an order of the account data elements according to one or more of: the size of a quantitative attribute of each account data element, the alphabetical placement of a qualitative attribute of each account data element and a preconfigured priority of an attribute of each account data element. Said rendering could comprise rendering the images vertically or horizontally in said order.

Said rendering could comprise rendering a respectively vertically or horizontally scrollable page.

Said rendering could comprise rendering the images on a page of a fixed size, the images being scaled and positioned to maximize the area of the page occupied by images.

The images could comprise numerals representing the value of the corresponding quantitative attributes of the account data elements. The font size of said numerals could be scaled with the image size.

Said scaling could be above a predetermined minimum font size.

The quantitative attribute could be an individual transaction amount. The account data could be for a multi-currency digital wallet comprising a plurality of digital purses for funds in respective currencies. The images could comprise one or more currency identifiers indicating one or more of said purses used to settle the respective transactions.

Said currency identifiers could be configured to be selectable by means of a user interface device to hyperlink to a rendering of: amount taken from the respective purse indicated by the currency identifier for the respective transaction; current balance for the respective purse indicated by the currency identifier, or transactions completed in the period using the respective purse indicated by the currency identifier.

According to a second aspect there is provided a user device configured to perform the method of the first aspect.

According to a third aspect there is provided a system comprising a user device, said system being configured to perform the method of the first aspect.

Said system could comprise a server and a user device. Said processing could be performed by said server or said user device. Said rendering could be performed by the user device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Implementations will now be described in detail, by way of example only, with reference to the accompanying drawings, in which:

FIGS. 1A and 1B show table arrangements for displaying account information;

FIG. 2A shows a recent transactions page;

FIG. 2B shows an individual transaction page;

FIG. 2C shows a transaction details page;

FIG. 2D shows a purse balances screen;

FIG. 3 shows a flowchart of a method for displaying account information;

FIG. 4 shows a schematic of an example system; and

FIGS. 5A to 5C show schematics of example data flows.

### DETAILED DESCRIPTION

The following embodiments provide an improved method and system for displaying account information, resulting in a more efficient GUI to account data. They improve on known systems by presenting a user with key information which can be understood intuitively. They can also provide for intuitive exploration of details of the account information.

In addition, applying a consistent and recognizable style to account information GUIs and paths between them in a financial application helps to authenticate the application to the user. The manner of displaying account information can thus act as a security feature, reassuring the user that they are using a trusted provider's genuine interface to access their sensitive personal data.

Prepaid cards operate in a similar way to standard credit cards except prepaid typically signifies that the cardholder accesses pre-loaded value, rather than a line of credit. There are many possible permutations of a prepaid program. Funds can be loaded by the consumer, a corporation or a government entity, as per the individual needs and purpose of the programme. Funds loaded onto prepaid cards are typically held in a pooled account, not on the physical card itself. Unlike conventional debit or credit cards, prepaid card transactions are always authorized online, reducing the potential for fraudulent use as compared to stored-value cards. As all transactions are recorded automatically it is possible for issuers to track when uploads and subsequent spends take place and monitor how the funds are spent.

One type of prepaid card is a multi-currency card. Such cards operate as electronic wallets having purses for holding funds in a plurality of currencies. Purses are loaded in advance of anticipated use. For example, prior to a trip requiring multiple currencies, an estimate can be made of the amount that will be spent on the trip in each currency and the card loaded accordingly. Card loading can be timed to take advantage of favorable currency conversion rates.

When a payment is made using a multi-currency card, funds are debited according to a particular algorithm. For example, any funds in a purse corresponding to the transaction currency are typically used in the first instance to avoid currency conversion fees and/or unfavorable conversion rates. If the amount in that purse is insufficient, the transaction can be completed by taking funds from other purses. For example, a second purse could be chosen according to which purse holds a currency with the most favorable current conversion rate to the transaction currency. If the second purse also contains insufficient funds to complete the transaction, the next most favorable purse can be debited and so on until the payment is complete.

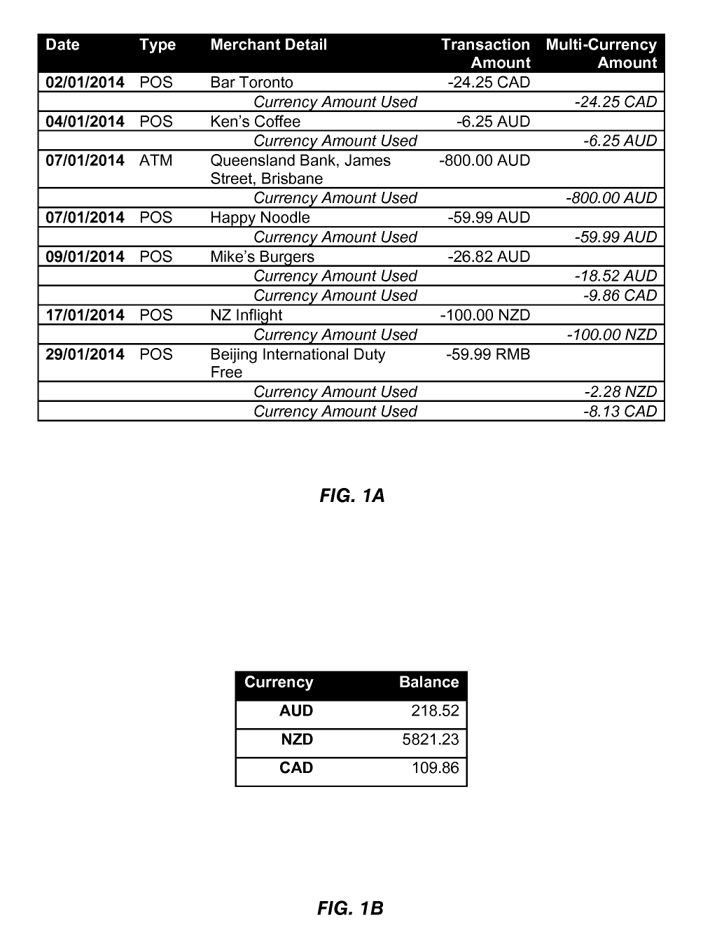

FIG. 1A shows an example of a conventional table arrangement for displaying account information, in this case transaction data for a multi-currency card over a particular period, for example, one month. Each row of the table contains data relating to a particular transaction, with columns containing respective attributes of the transaction: transaction date, transaction description or type (for example, purchase at a point of sale (POS)/reload/ATM withdrawal/bank transfer/card fee), merchant name, transaction currency, transaction amount and the amount taken from each purse to complete the transaction.

FIG. 1B shows an example of a conventional table arrangement for displaying account information, in this case digital purse data for a multi-currency card. The current balance of each purse is displayed in the table.

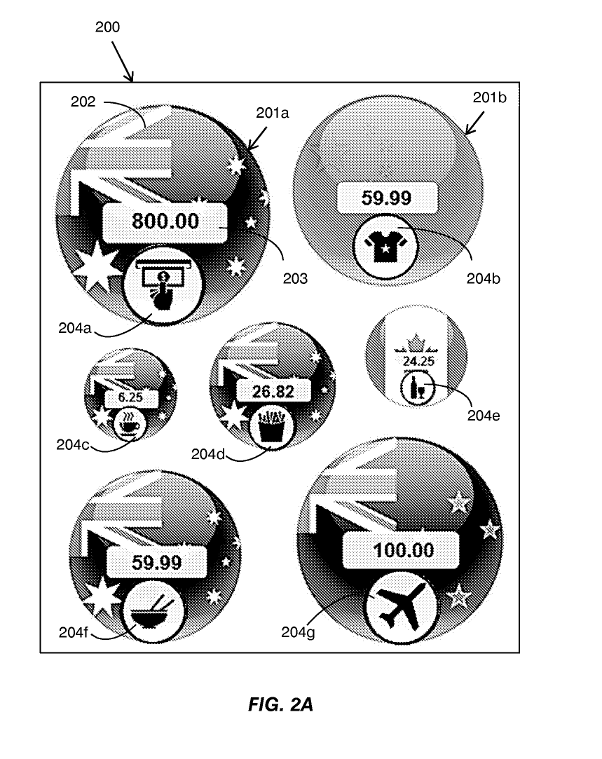

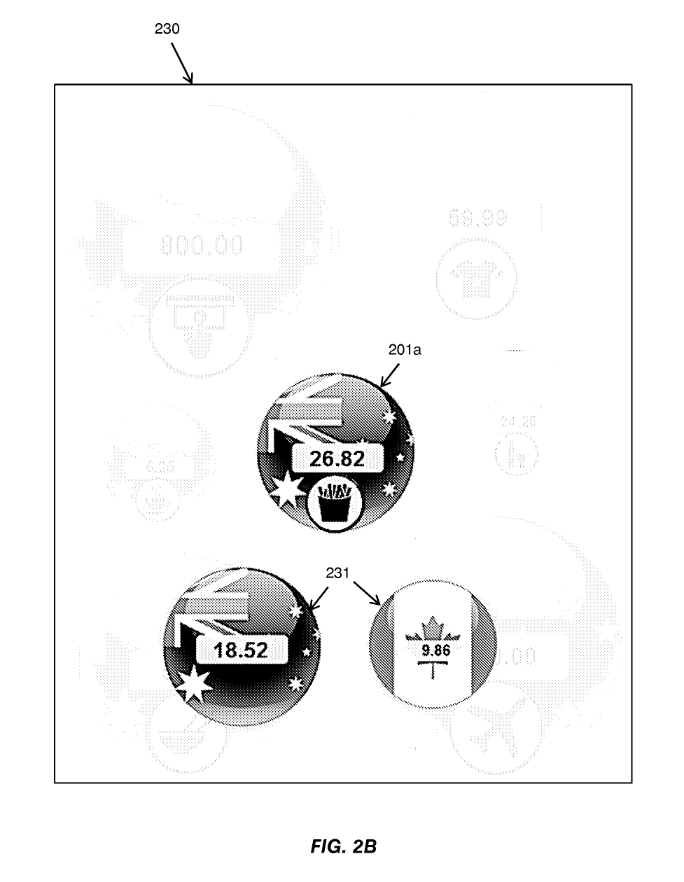

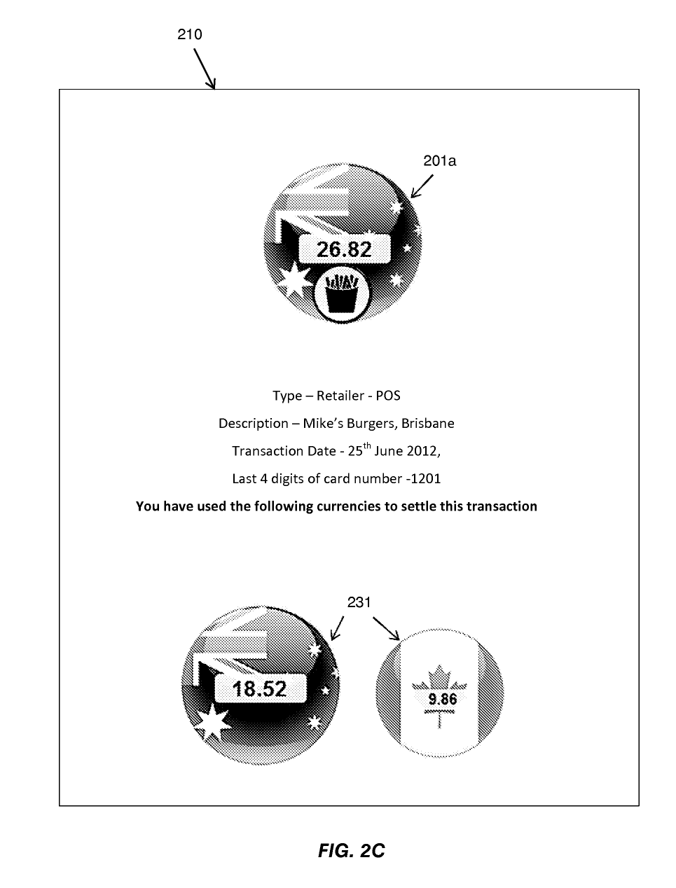

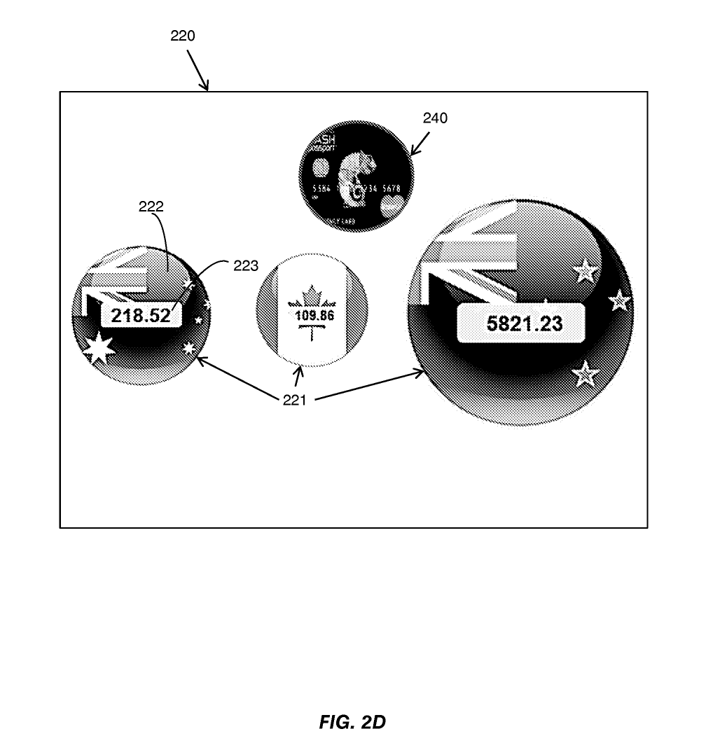

FIG. 2 shows an example of how the information contained in FIG. 1 could be displayed in a manner which facilitates intuitive understanding of the information by a user. Such a display could be presented on a GUI of a user device such, as a smartphone, tablet or laptop screen or a personal computer or smart television monitor.

FIG. 2A shows a recent transactions page 200. This could be provided, for example, as the home screen of an account management application or website. It could show, for example, transactions made on the user's account in the last month. Other transaction pages for other date ranges could also be provided.

Each image 201 represents a particular transaction. The relative sizes of the images 201 indicate the relative sizes of the transactions they represent, converted to a home or standard currency. Variation in image size could be above a predetermined minimum image size to ensure components of the image can be recognized by a user.

A background part 202 of each image is a flag indicating the currency of the transaction.

Numerals 203 overlaid on the flag part 202 indicate the value of the transaction in the currency denoted by the flag. The font size of the numerals 203 can vary with the overall size of the respective image 201, optionally above a minimum font size to ensure readability. The font colour of the numerals 203 could indicate whether the amount is positive or negative, for example, credits to the account could be in black and debits from the account in red. Alternatively a plus/minus sign could be included in front of the numerals 203 as appropriate. No explicit indication of debit/credit is required however; the user could infer this information from the transaction type icon 204, described below. The numerals 203 could optionally be preceded by appropriate currency symbols such as £, $, [symbol] , or codes such as GPB, USD, EUR or such symbols/codes could be used instead of or comprise part of the design of background flags 202.

Icons 204, also overlaid on flags 202, indicate the nature of the transactions. For example, icon 204a in image 201a indicates an ATM withdrawal, icon 204b in image 201b indicates a purchase from a clothing retailer, icon 204c indicates a payment to a coffee shop, icon 204d indicates a payment to a fast food outlet, icon 204e indicates a payment to a bar, icon 204f indicates a payment to a takeaway and icon 204g indicates a payment to an airline.

In FIG. 2A, images 201 are arranged to fit on a single page of a fixed size, positioned to make the most efficient use of the available space. They could instead be arranged in a particular order horizontally or vertically on a page which can be scrolled horizontally or vertically respectively. For example, they could be arranged in ascending or descending order of date or size. If arranged in date order, scrolling to either end of the current date range could present the user with a selectable option to display an adjacent date range or manually input a date range for display. Alternatively, images 201 could be arranged alphabetically by a textual attribute such as transaction currency, transaction type, merchant name or merchant type. The ordering could be configurable by a user. For example, a user might wish to see transactions made in their home currency first, or could be monitoring how much they are spending on different kinds of purchases so could set images 201 to be arranged in order of merchant type, perhaps with a category they wish to closely monitor spending on positioned first.

Images 201 of FIG. 2A could be user-selectable by means of a user interface device to hyperlink to more detailed transaction information. Such selection could, for example, be performed by tapping a touch screen above the desired transaction image 201 or positioning a cursor above the desired transaction image using a mouse or touchpad and clicking a selector button.

FIG. 2B shows an individual transaction page 230 which can be accessed by selecting image 201a of FIG. 2A. All of the images 201 except for image 201a are blurred or watermarked. Images 231 are superimposed on blurred/watermarked parts of the page to show the amounts taken for the transaction from each purse. Images 231 are structured similarly to images 201, except that icons 204 are not included. The relative sizes of the images 231 indicate the relative sizes of the portions of the transaction they represent, converted to a home or standard currency. Variation in image size could be above a predetermined minimum image size to ensure components of the image can be recognized by a user. Selecting an empty part of the page could cause navigation back to the recent transactions page 200 of FIG. 2A.

FIG. 2C shows a transaction details page 210 which can be accessed by selecting image 201a of FIG. 2B. Image 201a is shown again, followed by a list of other transaction details including date and type. The merchant name could also be listed or its logo displayed. The purses used to settle the transaction are also displayed as images 231. The relative sizes of the images 231 indicate the relative sizes of the portions of the transaction they represent, converted to a home or standard currency. Variation in image size could be above a predetermined minimum image size to ensure components of the image can be recognized by a user. Selecting an empty part of the page could cause navigation back to the individual transaction page 230 of FIG. 2B.

FIG. 2D shows a purse balances page 220 which can be accessed by selecting any of images 231 on the individual transaction page 230 of FIG. 2B, or the transaction details page 210 of FIG. 2C. This displays the information present in the table of FIG. 1B in a graphical form. Each image 221 represents a particular electronic purse. The relative sizes of the images 221 indicate the relative balances of the purses they represent, converted to a home or standard currency. Variation in image size could be above a predetermined minimum image size to ensure components of the image can be recognized by a user.

A background part 222 of each image is a flag indicating the currency of the purse.

The numerals 223 overlaid on the flag part 222 indicate the balance of the purse in that currency. The font size of the numerals 223 can vary with the overall size of the respective image 221, optionally above a minimum font size to ensure readability.

In FIG. 2D, images 221 are arranged to fit on a single page of a fixed size, positioned to make the most efficient use of the available space. They could instead be arranged in a particular order horizontally or vertically on a page which can be scrolled horizontally or vertically respectively. For example, they could be arranged in ascending or descending order of size. Alternatively, they could be arranged alphabetically by currency or associated country/common market name. The ordering could be configurable by a user. For example, a user could wish to see their home currency purse balance first, or could be monitoring how much they are spending in different countries so could set images 221 to be arranged in a particular purse order.

Selecting one of the images 221 could cause navigation to a page displaying a subset of the images 201 from the recent transactions page 200 of FIG. 2A, representing only transactions which used funds from that purse. Selecting a card image 240 could cause navigation back to the recent transactions page 200 of FIG. 2A.

If a user holds multiple accounts, instead of the recent transactions page, the home page of the application could be an account summary page similar to the purse balances page 220, showing the current balance of the user's accounts graphically, with images representing each account sized relative to one another according to their relative balance amounts. Hyperlinks could then be provided from each of these images to a corresponding recent transactions page for that account.

Further hyperlinks could be provided from the images and image components described above. For example, selecting an icon 204 could lead to a type-specific recent transactions page, that is, selecting icon 204a leads to a page showing only ATM withdrawals and selecting icon 204b leads to a page showing only clothing purchases. Such pages would show a subset of the images 201 which could be ordered in any of the manners discussed above for ordering of images 201 on the recent transactions page 200. Such ordering may or may not match that of the recent transactions page 200.

Alternatively, selecting an icon 204 could lead to a grouped by type recent transactions page, that is, a page comprising images each representing all recent transactions of a particular type, allowing a user to compare their spending on various types of goods and services. For example, an image could have a background part formed of the appropriate one of icons 204a to 204g, superimposed by the total amount spent on transactions of that type, converted into a home or standard currency. The size of the image could correspond to this total amount so that the more spent on a particular type of transaction in the recent period, the larger the image. Small flags could also be superimposed on the background part of the image, indicating the currencies of the various transactions comprised in the group. These flags could be hyperlinked, just like images 231.

Other grouped transaction pages could be envisaged, for example, which group transactions by transaction currency, date or day of the week. Suitably, such pages could be accessed by selecting related images or image components on other pages as for the grouped by type recent transactions page described above.

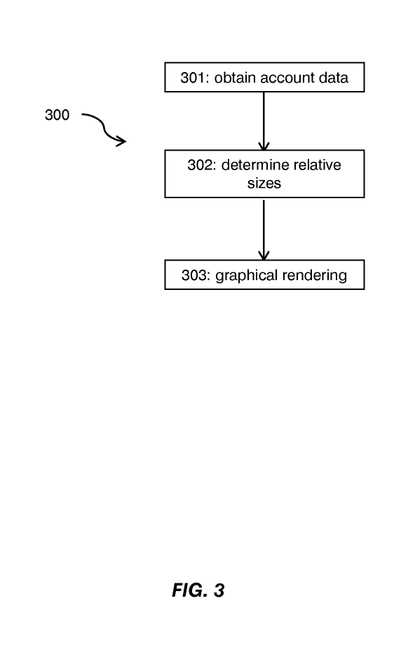

FIG. 3 shows a flowchart of a method 300 for rendering account information for display on a GUI. At step 301, account data is obtained for one or more accounts. At step 302, the account data is processed to determine relative sizes of a quantitative attribute of a plurality of comparable account data elements. At step 303, at least some of the account data is rendered graphically, for example, according to a sizing algorithm, such that each of the account data elements is represented by an image, relative sizes of the images indicating relative sizes of the corresponding quantitative attributes of the account data elements.

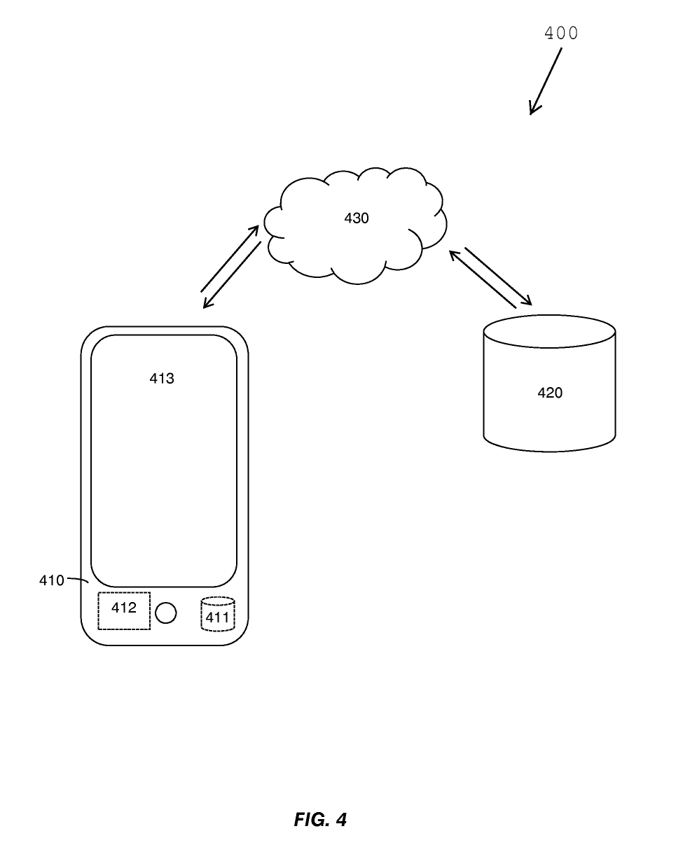

As an example, to display recent transaction page 200, transaction data is first obtained for the account in question, filtered by a transaction date range covering the last month. This could, for example, be downloaded to a user device 410 from an account provider server 420 over a secure internet connection 430, as shown in the schematic of an example system 400 illustrated in FIG. 4. Alternatively, the user device could store the transaction data locally in memory 411, for example, if transactions are made using the user device.

The amount, currency and date of each transaction is then identified by processor 412 so that a conversion to a home or standard currency can be performed. To perform the conversion, a conversion rates file is obtained which stores the conversion rates between the home or standard currency and all the relevant currencies by date. Again, this file can be obtained over the internet connection 430 from account provider server 420, or can be obtained from local memory 411 or in any other suitable way. The appropriate conversion rate is then applied to each transaction amount. Each converted transaction amount is then divided by the total of all the converted transaction amounts to obtain a fractional transaction amount.

The fractional transaction amounts are input to a sizing and ordering algorithm which determines an appropriate image size of at least a predetermined minimum image size for each transaction such that images are scaled with fractional transaction amounts and the maximum possible use is made of the page area available. The images, which can comprise scaled numerals, icons and flags as described above, are then rendered to a GUI by selecting the appropriate image components (which again can be stored locally or retrieved over a network), sizing them and positioning them on a page.

Finally, Screen 413 displays recent transactions page 200.

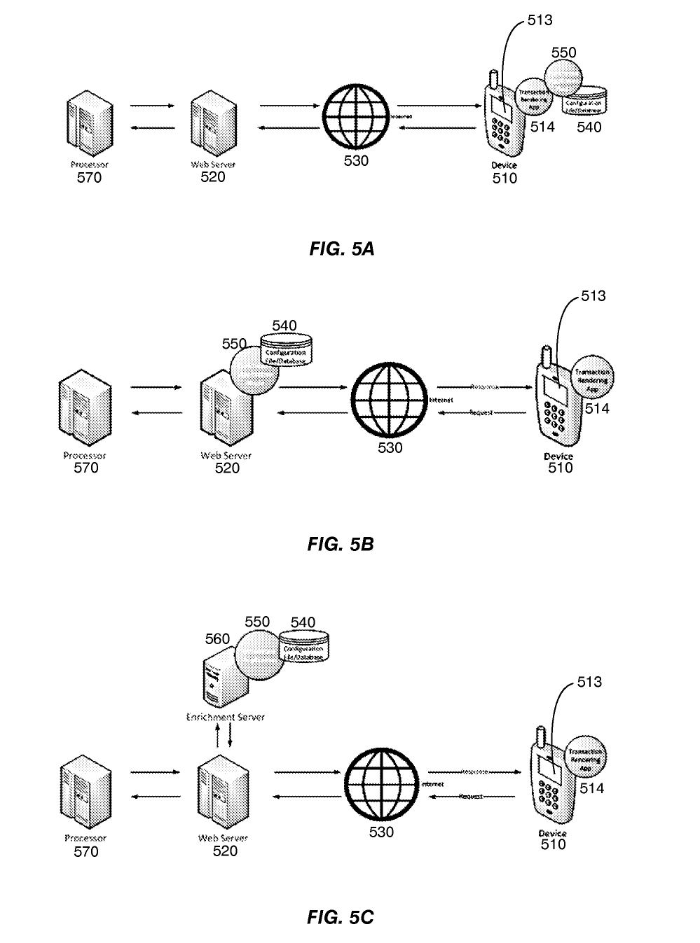

FIG. 5 illustrates example system configurations in which a system comprises a user device 510 (such as a smartphone), and a (web) server 520 connected by a network (such as the Internet) 530. The server 520 in turn connects to a card processor 570 from which transaction data is obtained.

In the example of FIG. 5A, a rendering engine is integrated into an application 514 on the user device 510. Transaction data is collected by the user device 510 from the server 520 via the network 530 and stored in a configuration file or database 540. An enrichment application plugin 550 provides the application 514 with access to configuration file/database 540 and the application 514 renders it to screen 513.

In the alternative example of FIG. 5B, the rendering engine is integrated into the server 520 in the form of a plug-in application 550 and configuration file or database 540 that are used by the server 520 to enrich data in a response message it sends to the user device 510 in response to receiving a request from the user device 510. The rendering application 514 on the user device 510 then need only render the data to the screen; the user device 510 does not have to do any processing of the data. This reduces the processing power required at the user device 510. If the user device 510 is mobile this is particularly advantageous since it results in increased battery life.

In the alternative example of FIG. 5C, there is a separate enrichment server 560 running an enrichment application 550 and storing a configuration file/database 540. The enrichment server 560 receives requests for data enrichment from the web server 520 and responds to it with enriched data. The web server 520 then passes the enriched data to the user device 510 in response to a request.

A request for data can be in a number of formats, for example, fixed field, delimited field, csv, XML, SOAP-XML or JSON. However, data does not necessarily have to be requested by a user device (or, in the example of FIG. 5C, a web server); data can, instead, be delivered on a ‘push’ basis, for example, according to a predefined schedule or when the user device has WiFi access.

The configuration file/database 540 stores data required for processing and rendering of transaction data, for example, currency exchange rates and image files matched to particular currencies, merchant or transaction type categories.

A mobile web browser could be used to display the transaction information instead of application 514. Requests could be made from a HTML page with a suitable language such as JavaScript or Java.

Many modifications and variations can be made to the above-described embodiments within the scope of the present disclosure.

Other embodiments will be apparent to those skilled in the art from consideration of the specification and practice of the embodiments disclosed herein. It is intended that the specification and examples be considered as exemplary only, with a true scope and spirit of the disclosure being indicated by the following claims. In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claims.

It should be appreciated that the functions and/or steps described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method comprising:
processing account data obtained for one or more accounts to determine relative sizes of a quantitative attribute of a plurality of comparable account data elements; and
rendering at least some of said account data graphically such that each of said account data elements is represented by an image, relative sizes of said images indicating relative sizes of the corresponding quantitative attributes of the account data elements.

2. The method according to claim 1, further comprising displaying the images on a graphical user interface.

3. The method according to claim 1, wherein:
the account data is transactional data relating to transactions completed on said one or more accounts within a predetermined period; and
said quantitative attribute is either an individual transaction amount for each of said transactions or a composite transaction amounts for a plurality of groups of said transactions.

4. The method according to claim 1, wherein:
the account data is data relating to a plurality of digital purses associated with said one or more accounts; and
said quantitative attribute is a balance of each of said plurality of digital purses.

5. The method according to claim 2, wherein one or more of the images are configured to be selectable by means of a user interface device to hyperlink to a rendering of further information relating to the respective account data elements.

6. The method according to claim 2, wherein:
the images comprise a plurality of component images; and
one or more of said component images are configured to be selectable by means of a user interface device to hyperlink to a rendering of further information relating to a subset of the account data elements whose representative images comprise a component image that has been selected.

7. The method according to claim 3, wherein said processing comprises extracting from the transactional data, for each transaction to which the transactional data relates, one or more attributes selected from: numerical value, currency, transaction type, merchant, merchant type, transaction date, settlement date and location.

8. The method according to claim 3, wherein said processing comprises converting the numerical value of each transaction to which the transactional data relates to a predetermined currency.

9. The method according to claim 8, wherein said converting comprises obtaining a currency conversion rate for a transaction date of each transaction to which the transactional data relates.

10. The method according to claim 1, wherein:
said processing comprises determining an order of the account data elements according to one or more of:
the size of a quantitative attribute of each account data element, the alphabetical placement of a qualitative attribute of each account data element, and
a preconfigured priority of an attribute of each account data element; and
said rendering comprises rendering the images vertically or horizontally in said order.

11. The method according to claim 10, wherein said rendering comprises rendering a respectively vertically or horizontally scrollable page.

12. The method according to claim 1, wherein said rendering comprises rendering the images on a page of a fixed size, the images being scaled and positioned to maximize the area of the page occupied by the images.

13. The method according to claim 1, wherein the images comprise numerals representing the value of the corresponding quantitative attributes of the account data elements, the font size of said numerals being scaled with the image size.

14. (canceled)

15. (canceled)

16. A user device comprising:
a memeory; and
a processor coupled to the memory, the processor configured to:
process account data obtained for one or more accounts to determine relative sizes of a quantitative attribute of a plurality of comparable account data elements; and
render at least some of said account data graphically such that each of said account data elements is represented by an image, relative sizes of said images indicating relative sizes of the corresponding quantitative attributes of the account data elements.

17. A system comprising the user device of claim 16.

18. A system comprising:
a server configured to process account data obtained for one or more accounts to determine relative sizes of a quantitative attribute of a plurality of comparable account data elements; and
a user device coupled to the servicer, the user device configured to render at least some of said account data graphically such that each of said account data elements is represented by an image, relative sizes of said images indicating relative sizes of the corresponding quantitative attributes of the account data elements.
